(19) United States
(12) Patent Application Publication
(10) Pub. No.: US 2006/0013511 A1
(43) Pub. Date: Jan. 19, 2006

(54) Method and apparatus for identifying optical media

(76) Inventors: Brian De Champlain, Waterloo (CA); David Macrae, Burlington (CA); John Stevenson, Oakville (CA); Nebojsa Jovanovic, Burlington (CA)

Correspondence Address: PEARNE & GORDON LLP, 1801 EAST 9TH STREET, SUITE 1200, CLEVELAND, OH, 44114-3108, US

(21) Appl. No.: 10/892,628

(22) Filed: Jul. 16, 2004

(51) Int. Cl. G06K 7/10

(52) U.S. Cl. 382/321

(57) ABSTRACT

The present invention provides a method and an apparatus for identifying optical storage media comprising: means for capturing an image of an identification ring disposed upon an optical media disc; means for unwrapping the ring to form a flat band; means for searching of the flat band to locate a full string of symbols or characters; means for segmenting the string into individual symbols or characters; means for identifying problem symbols or characters associated with the individual symbol or character; and means for checking each individual symbol or character to determine an acceptable symbol or character and comparing the individual symbol or character to both the acceptable symbol or character and the associated problem symbol or character to determine which is a closer match. An embodiment of the apparatus for identifying optical storage media includes a computer system having a CPU, a keyboard, a display unit and a media identification module; and a camera head having a multi-spectral lighting system.

### FIELD OF THE INVENTION

The present invention relates to a method and apparatus for identifying optical media and is particularly concerned with identifying optical CD and DVD media by optically reading the identification band on the media inserted during the fabrication process.

### BACKGROUND OF THE INVENTION

Prior art require special setup of the system for different media types. One such system only outputs bar code data to external devices. Prior art systems do not support multiple implementations of Correct Code Management. They do not support configurable multi-title operation and can not provide multi-title processing on one PC. Prior art systems cannot read “overlapping” codes on double-layer discs, where the codes on the independent halves became superimposed during the bonding process. Prior art systems cannot read each characters individually.

Consequently, false reject rates of prior art systems has been an issue.

### SUMMARY OF THE INVENTION

An object of the present invention is to provide an improved method and apparatus for identifying optical media.

In accordance with another aspect of the present invention there is provided a method of identifying optical storage media comprising the steps of capturing an image of an identification ring disposed upon an optical media disc; unwrapping the ring to form a flat band, searching of the flat band to locate a full string of graphic symbols or characters; segmenting the string into individual symbols or characters, identifying problem symbols or characters associated with the individual symbols or characters; and checking each individual symbol or character to determine an acceptable symbol or character and comparing the individual symbol or character to both the acceptable symbol or character and the associated problem symbol or character to determine which is a closer match.

In accordance with an aspect of the present invention there is provided an apparatus for identifying optical storage media comprising: means for capturing an image of an identification ring disposed upon an optical media disc; means for unwrapping the ring to form a flat band; means for searching of the flat band to locate a full string of symbols or characters; means for segmenting the string into individual symbols or characters; means for identifying problem symbols or characters associated with the individual symbols or characters; and means for checking each individual symbol or character to determine an acceptable symbol or character and comparing the individual symbol or character to both the acceptable symbol or character and the associated problem symbol or character to determine which is a closer match.

The various embodiments of the present invention include one or more of the following improvements:
Present system requires no setups or adjustment regardless of media type of color. It can read discs automatically. No user setups are required
System perform comparison of bar codes
System can read overlapping codes on double layer dics by the use of monochromatic light which is reflected by one layer and absorbed by the second layer.
System segmentation process to separate the word image into single characters then analyzes the characters individually not the whole image as a block. This dramatically improves the reliability of the process.
System cleans the optical window using a flow through ventilation system. This is an improvement, because dust on the lens is directly proportional to the reliability and effectiveness of the system.
System camera positioning system is an improvement over prior art. It improves the centering and robustness of the camera positioning. The position of the camera in pivotal to the unwrap tolerance, especially for smaller media discs where the identification code is much smaller in size. The ability of the system to read the code is affected if the ring of code being in not in the correct place.
Media detecting system provides a method of identifying the cause of a reject. This information is important when a user is tracking the operation through a real time monitoring system. The present system can tell the user if the reject was cause by the reading system or the pick and place system. If the disc was not properly placed on the reading system then the pick and place is to blame. It can also tell the system if the disc was not removed from the system, hence the following reject was also the fault of the pick and place system.
Multi-spectral focused lighting system provides ability to tune the light source to the correct wavelength for a specific media type. In present day media manufacturing, a number of new materials and colors are used to make discs. Some have dark colors of opaque or semi opaque plastic. This makes it impossible to read with simple white light. So the light source must be programmable and self-adjusting. This is especially important since the system must be totally self adjusting so that no adjustments be required to read different media discs.

### BRIEF DESCRIPTION OF THE DRAWINGS

The present invention will be further understood from the following detailed description with reference to the drawings in which:

FIG. 1 illustrates an apparatus for identifying optical media in accordance with an embodiment of the present invention;

FIG. 2 illustrates the vision inspection camera head of FIG. 1;

FIG. 3 illustrates in a partial cut-away perspective the vision head assembly of FIG. 2;

FIG. 4 illustrates detail of the partial cut-away perspective of FIG. 3;

FIG. 5 illustrates in a block diagram the various components of the lighting device and controller;

FIGS. 6a, 6b and 6c illustrate the preferred embodiment of the vision inspection camera head of FIG. 1;

FIG. 7 illustrates the internal media detection system of FIG. 5;

FIGS. 8a and 8b illustrate the air flow through dust removal system;

FIG. 9 illustrates in cross-section the chassis extruded from aluminum;

FIG. 10 illustrates in a cut-away perspective view, detail of the media-locating pin;

FIG. 11 shows the relationship of the major software components;

FIG. 12 illustrates a five-step detection process in accordance with an embodiment of the present invention;

FIG. 13 illustrates the three main operational modes of the ID Software System;

FIG. 14 illustrates in a flow chart an overview of the online process;

FIG. 15 illustrates the batch setup process;

FIG. 16 illustrates work order collection;

FIG. 17 illustrates correct code data collection;

FIG. 18 illustrates the Image Processing Engine for Batch Setup;

FIG. 19 graphically illustrates unwrapping;

FIG. 20 illustrates code detection details;

FIG. 21 illustrates in a flow chart the inspection process;

FIG. 22 illustrates in a flow chart the engine image processing re. inspection; and

FIG. 23 illustrates in a flow chart the code verification process.

### DETAILED DESCRIPTION OF THE PREFERRED EMBODIMENT

Referring to FIG. 1, there is illustrated in a block diagram an apparatus for identifying optical media in accordance with an embodiment of the present invention.

The optical media reading system 10 is designed to an indentification code from optical discs. The ID system includes at least one vision inspection camera head 12, a computer system 14, having a CPU 16, a keyboard 18, a display unit 20, a bar code scanning system 22, an optional client database 24, software (not shown in the figure) and a host machine 26 for operation by a user 28.

The vision heads 12 are mounted on the host machine 26 and interface through the computer 14 with the host machine PLC system (not shown in the figure).

In operation, the host machine 26 places a media disc on the head 12 and then signals the reading system 10 to begin the reading process. The reading system 10 then communicates with the reading head 12 to set the color and intensity of lighting required, as well as the camera exposure time and focus. These adjustments can be done in fully automatic mode or in manual mode.

The system 10 then begins the acquisition and processing functions. Once completed, the system 10 either rejects or passes the disc depending on whether the required identification code was read or could not be read. The system 10 then updates a manufacturing report file with the results, and displays the rejected disc image if required.

A hand-held or fixed-mount bar code scanner 22 is an optional accessory to the ID system 10. Depending on optional software modules activated, the scanner can be used to:

1. Enter the Work Order Number when starting a batch.

2. Scan an employee ID badge when logging in to the system.

3. Scan in the expected ident-code data.

The system 10, as shown in FIG. 1, supports most RS-232 scanners, however other scanner interfaces such as keyboard wedge or USB can also be supported.

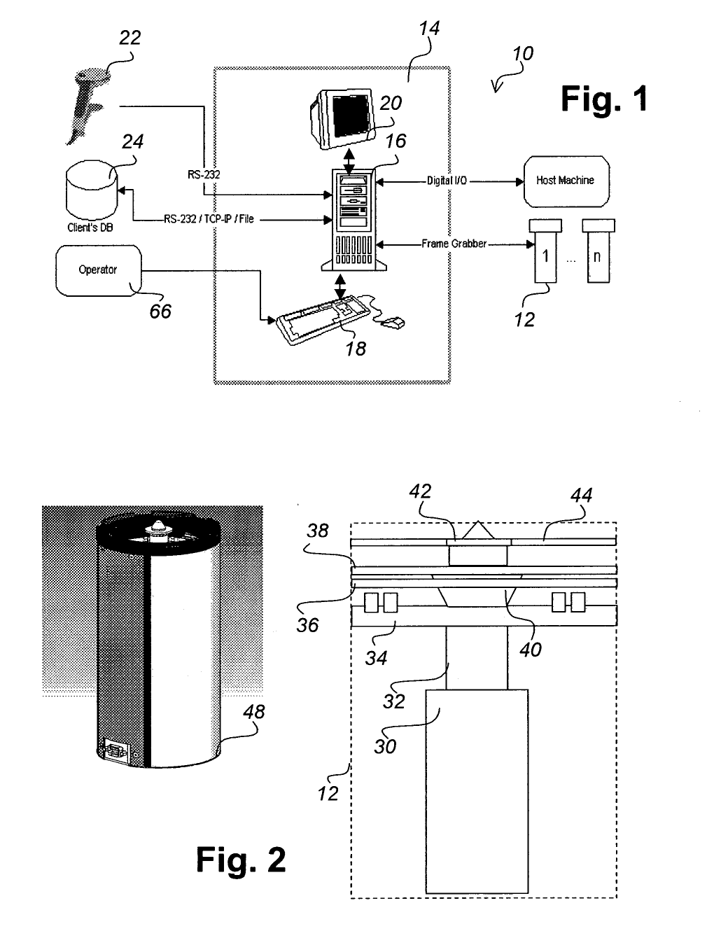

Referring to FIG. 2 there is illustrated the vision inspection camera head of FIG. 1. The vision head assembly 12 in accordance with one embodiment includes a video camera 30 with lens 32, a monochromatic LED lighting source 34, a diffuser 36, an optical window 38 and a shield 40.

In operation, the vision head assembly 12 uses the analog or digital video camera 30 with lens 32 for reading an ID band 42 on an optical CD or DVD 44. The acquisition can be achieved using a frame grabber card in the case of an analog camera or by a using digital camera that outputs a digitized signal via a serial Firewire or similar interface. A focusing lens 32 is used on the camera. The resulting digital signal is then processed and analyzed through a software application. The light source 34 is used to illuminate the objective to be acquired. A lens array may be used to shape and focus the light on the objective. A diffuser 36 may be used to diffuse light from the source 34. The diffuser 36 being tuned to pass a desired frequency band. An optical window 38 is used to stop dust and dirt from settling on the camera lens 32. A center media support pin 46 is mounted in the center of the optical window 38. The vision head assembly 12 has internal and external media sensors, not shown in FIG. 2, but described in detail herein below, that detect the presence of the media on the head. A flow through ventilation system is used to keep the dust and dirt from settling on the optical window 38. An extruded aluminum chassis 48 is used to house the components. The extrusion 48 provides individual chambers that keep the air flow from circulating in the camera area. A universal mounting slot is cast into the aluminum chassis. A separate airflow unit can be added to the basic product.

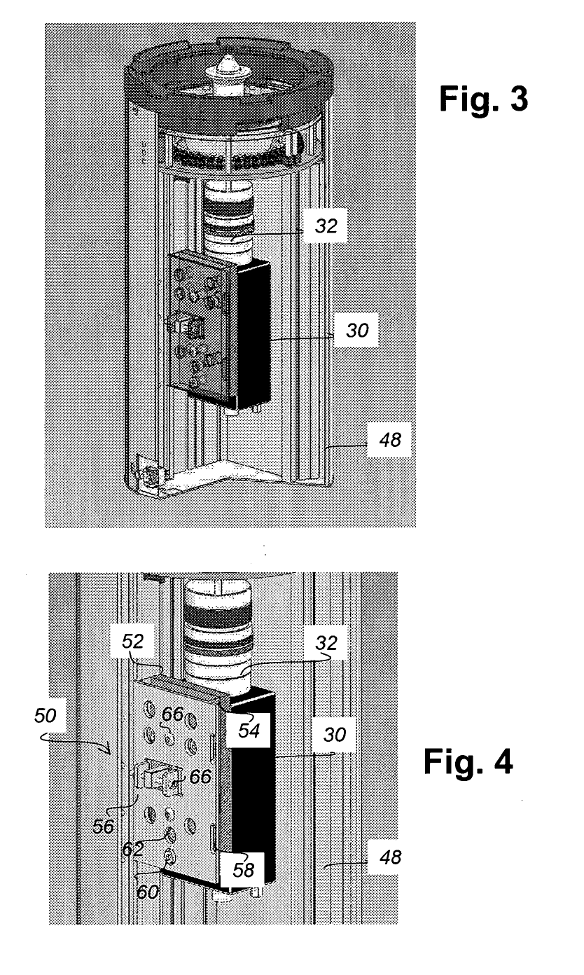

Referring to FIG. 3, there is illustrated in a partial cut-away perspective the vision head assembly of FIG. 2. The camera 30 can be an analog or digital video camera. In the preferred embodiment the camera has remote gain, focus and exposure control.

Referring to FIG. 4, there is illustrated detail of the partial cut-away perspective of FIG. 3. To maximize the precision, effectiveness and reliability of the system 10, the camera 30 must be precisely centered on the objective. The system allows for X, Y and Z camera adjustments. The camera mounting mechanism 50 is specifically designed for ease of assembly and to allow easy access and adjustments. The camera mounting assembly 50 includes three plates 52, 54, and 56. The camera 30 is mounted on a support plate 52. The support plate 52 is affixed to a spacer plate 54. The spacer plate 54 is mounted to a guide plate 56. The guide plate 56 is then slide into the slot in the main extrusion body 48. The guide plate 56 can be moved up or down to set the “Z” axis of the camera and then locked into place using “Z” locking screws 58.

The “X” axis of the camera can be adjusted using adjusting screw 60. Once adjusted, the “X” axis can be locked in place by tightening screw 62.

The “Y” axis of the camera can be adjusted by turning screw 64. The “Y” axis can then be locked in place by tightening screws 66.

The design makes it possible to replace the camera without having to re-adjust the position. The design is very robust and is not affected by vibrations.

The illumination system is a very crucial component of the overall system 10. The ability of the system to provide an evenly distributed focused light is pivotal to its operation.

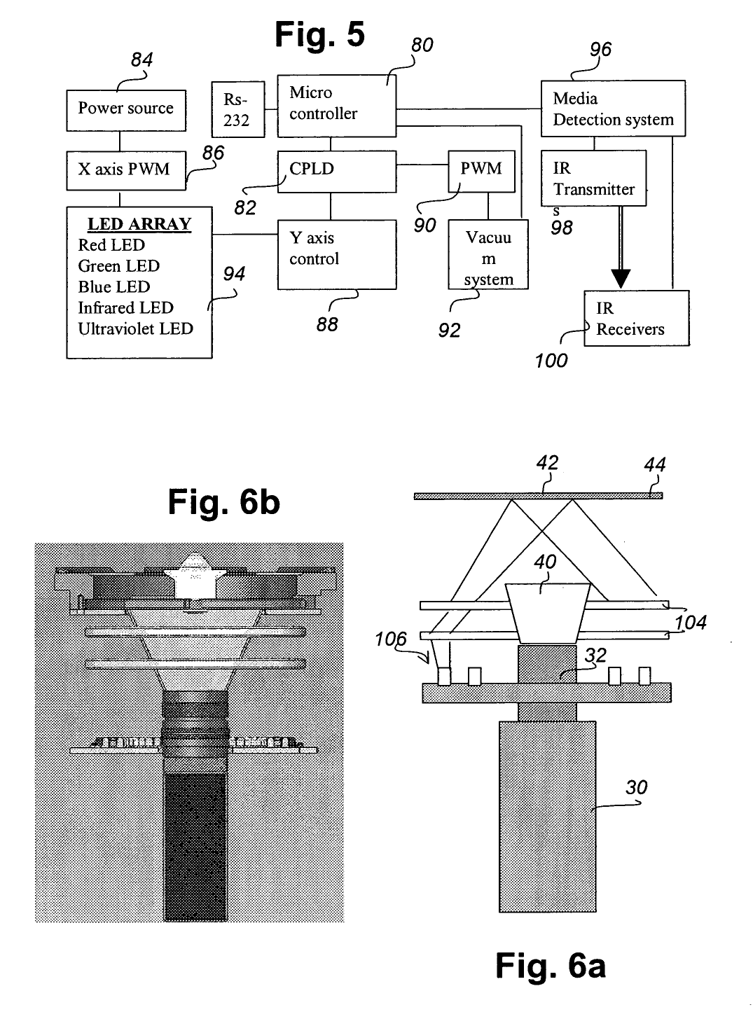

Referring to FIG. 5, there is illustrated in a block diagram the various components of the lighting device and controller.

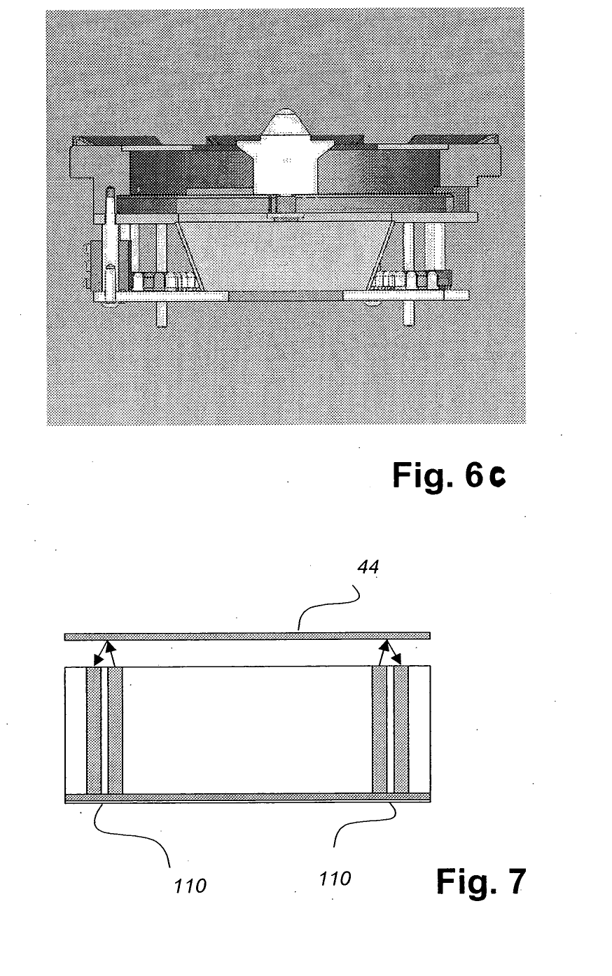

In the preferred embodiment of FIG. 6, the lighting system contains multi-spectral light sources 102 that can be digitally mixed to create a specific color of hue in all colors of the spectrum from infrared to ultraviolet. The power level 84 of the light source 94 can be controlled utilizing a pulse width modulation control signal generated by the complex programmable logic device 82. The PWM train controls the on time of the different colors of LED by varying the frequency and phase of the train to establish different mixes of color based on the average brightness of the selected color leds. The selected LEDs can have a unique frequency or phase of signal fed to them.

The light is focused on the region of interest 42 by a network of lenses 104 and specially selected high power, narrow beam, color LEDs 106. Focused light is important because it eliminates light reflections in the chassis that would normally end up on the camera lens 32, causing ghosting and distortions. The focused light also greatly improves the level of light on the object since it does not require a diffuser.

The multi-spectral focused light design is required when a system must read the identification code from DVD media that uses semi-opaque colored plastic instead of clear polycarbonate. Trying to use only diffused white light results in longer exposure and cycle times and increases the level of false rejects, because the long exposure time also increases the interference caused by dust and scratches.

Embodiments of the present invention incorporate an internal media detection system that can detect the presence of a media disc on the head of the system as shown in FIG. 7. The internal media detection system uses three infrared transmitter and receiver detector pairs 110 evenly dispersed around the head of the unit, so that it can sense the presence of a disc 44 and also sense that the disc is properly seated on the head. If all 3 sensors are not triggered then the disc is not properly placed on the head, if one or two sensors are triggered then the disc is present, but not properly placed.

This detector is a pivotal component in the system. It supplies a way of determining if a reject was caused by the pick and place machine or if it was a disc reading error.

Holes have been provided in the head design for mounting of external optical disc presence sensors (not shown). These sensors would normally be used by the pick and place system to know when a disc is placed.

An optical window was incorporated into the design to protect the camera 30 and to stop dust and moisture from accumulating into the unit. The window can be made of Glass, acrylic, or polycarbonate.

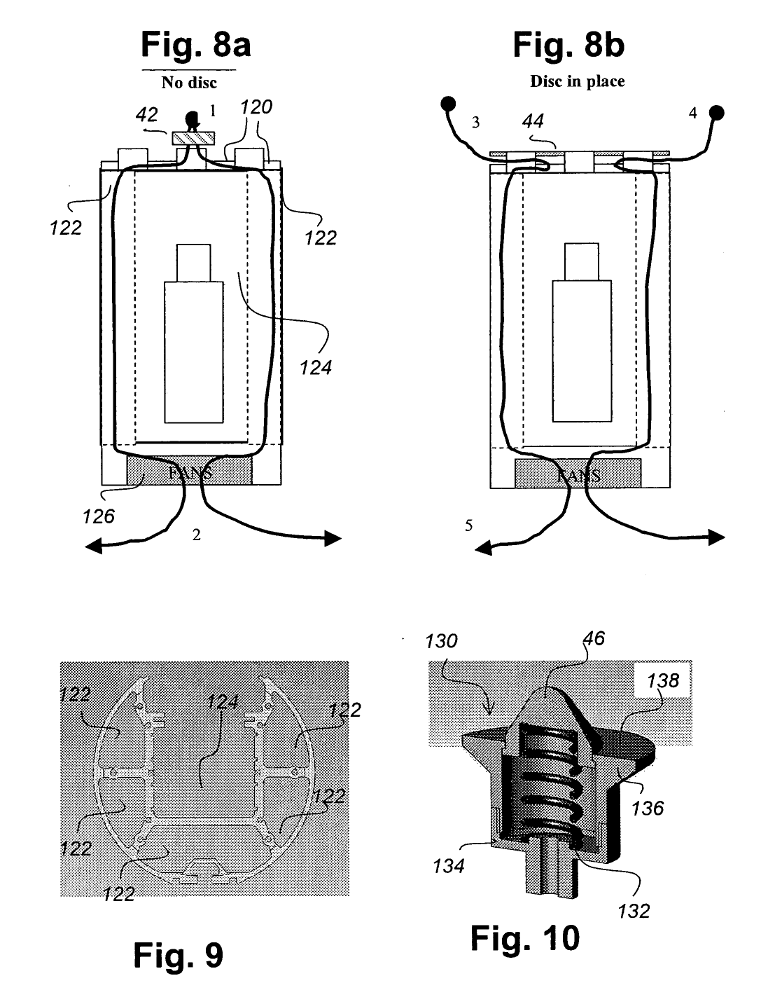

Embodiments of the present invention include a flow through ventilation system, as illustrated in FIGS. 8a and 8b, that controls the amount of dust that accumulates on the optical window. In certain environments, the system could be impaired by dust that sits on the optical window. The dust would normally increase the false reject rates until the system becomes totally ineffective.

As shown in FIG. 8a, the flow through system provides a focused suction in the region of interest 42 while the disc 44 is not in place, so that dust can be sucked from the air before it settles on the optical window. As shown in FIG. 8a, when the disc 44 is in place, the suction is diverted to the outside of the head to eliminate any possible suction on the disc. If suction is applied to the disc, it can have a negative influence on the pick and place machine and may make it impossible to remove the disc from the head. The special groves 120 around the head are incorporated to minimize the suction when the disc 44 is in place. The system provides special air chambers 122 where the air can flow from the top of the unit and out the bottom of the unit without flowing inside the sealed camera chamber 124. The system is powered from two inexpensive fans 126, one right hand and the other left hand turning to increase the static pressure of the inexpensive fans and for redundancy. The speed of the fans 126 is controlled by a microprocessor 80 that controls the amount of pressure in the vacuum and monitors the status of the fan.

The chassis 48 is extruded from aluminum as shown in cross-section in FIG. 9, and anodized black to reduce the light reflections inside the camera cavity 124. The extrusion is designed to provide separate cavities or chambers for the camera assembly and for the flow through ventilation system. This approach provides for a sealed chamber 124 where the air will not flow through, hence the camera and lens will not be subjected to the dust or dampness that may be in the air.

A center locating pin 46 is required to accurately center the disc 44 in the middle of the field of vision 42. Prior art systems have suffered from broken optical windows caused by the pick and place arm when trying to deposit a disc. To solve this problem, the pin 46 is designed to be shock absorbing to protect the optical window from being broken. The center pin 46 is designed to be free floating inside the main body 130 of the assembly. The pin assembly 130 includes four parts, lower 134 and upper 132 body components that screw together, a retractable centering pin 46 and a spring 132.

In operation, the spring 132 pushes the center pin 46 up to the top of the assembly 130. So when a disc 44 is misplaced, the center pin 46 can be pushed into the body 130 to absorb the shock. The body provided a shelf where the disc will rest. The shelf is designed to cover completely the clear center of the disc to limit the effect of ambient light.

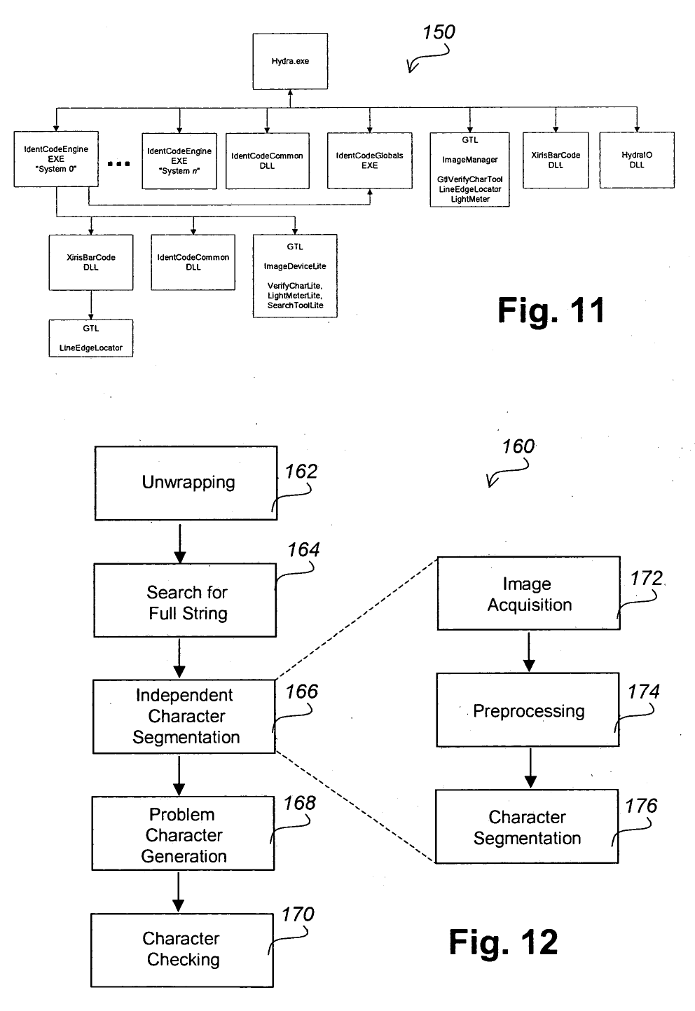

The ID system 150 includes a number of major modules, both in-process (DLL) and out-of-process (EXE) with respect to the main application. FIG. 11 shows the relationship of the major software components.

Referring to FIG. 12, there is illustrated a five-step detection process in accordance with an embodiment of the present invention. The figure outlines the character detection algorithm in the ID system, which uses a five-step process to detect the identification string.

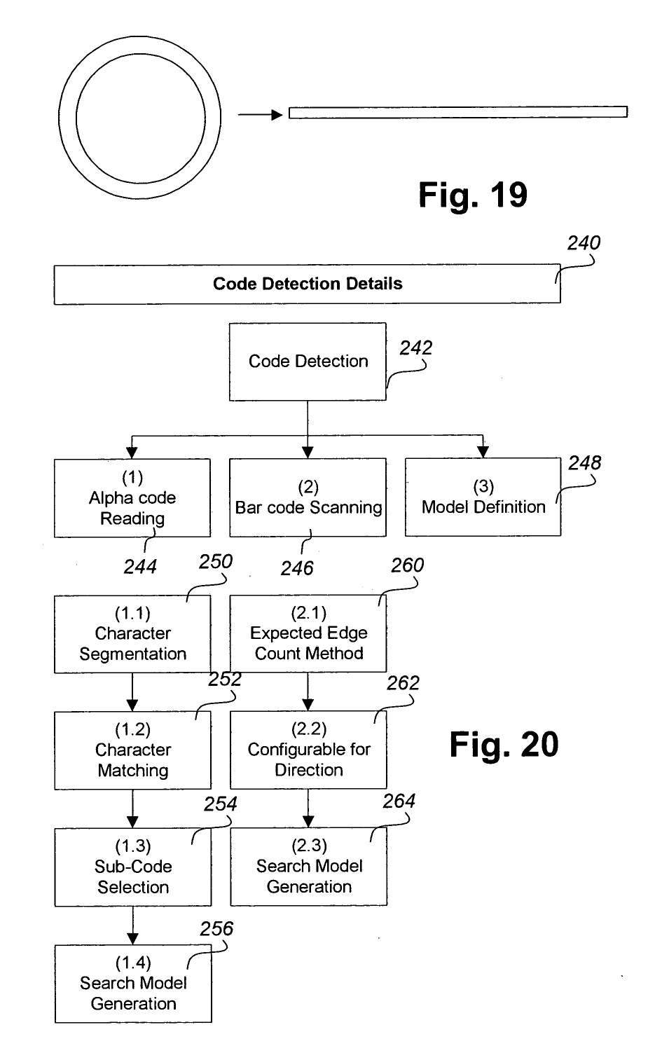

The ID band is unwrapped 162 from a ring into a flat band using bi-linear interpolation in order to keep precision, also shown graphically in FIG. 19. Some additional pixels are unwrapped because of the possibility that the ID code may lie on the “seam”. The overlap is made large enough that the entire string must be found somewhere in the band.

A Normalized Grayscale Correlation (NGC) search 164 is performed between the bitmap of the full character string and the unwrapped band. For example, we might look for the bitmap representation of the string “1234567890”. Because the orientation of the disk is completely random with respect to the camera, the string might be anywhere in the band.

Because of the overlap, the string may be found twice. This is not an error. Should the string be found twice, the one which is closer to the center of the band is chosen for verification. For example, the full unwrapped ring contained the string:

“--1234567890 | | ∥ --123456789C”.

In the unwrap of the ring, the second ‘0’ is clipped to a ‘C’ but the resulting string is still a match, since it still correlates highly. However, the string which is closer to the center is guaranteed to be complete. Note that on the next disk, the unwrap might look like:

“4567890 | | ∥ --1234567890| |”

In this case, only one copy of the ID string will be matched. On other disks, all the characters may appear only once.

Note that in practice, the ID string only covers a small portion of the band. The above example is for illustration only. In real systems, there is always far more space than shown here.

Once the band is located, each character in the string is verified independently 166 using an individual correlation for each one, thus preventing confusion with other, similar, strings. In the above example, the ‘0’ might be replaced by an ‘O’. Each character must be found at the correct location within the overall string in order for the ID code to be accepted.

When the font is initially taught, a list of characters that might cause confusion with each other is automatically generated 168. The set of characters included in the list is chosen based how similar they correlate with the correct character. The exact level of correlation which would cause a character to be added to the confusion list is parameterized. In practice, we have found that about 0.8 is correct.

In this example, ‘O’ would be listed as a possible problem character when searching for the ‘0’ because the correlation between the two characters is well above 0.9 in most fonts. Depending on the actual font, other characters like ‘D’ and ‘C’ would probably be placed in the list as well. Similarly, ‘1’ would be a problem character for the ‘1’ and ‘S’ might be for the ‘5’, ‘B’ for the ‘8’. And so on.

In order for the string to be accepted, two checks 170 are made for each character. First, an acceptable character must be found in the proper position. Secondly, it must resemble the correct character more than any of the possible problem characters.

Character segmentation 166 is used to locate individual characters and find their correct order according to position in the string image.

An algorithm segments input image into regions that contained individual characters. The built-in segmentation routine can distinguish between individual characters even under the most difficult imaging conditions. Automatic thresholding ensures that characters are identified properly.

Image is acquired 172 using a grayscale camera and a frame grabber. The size of characters on acquired image must not be less than 20 pixels. In case of smaller characters the appropriate recognition reliability cannot be achieved.

Preprocessing 174 includes image enhancement, normalization, filtering, polarity detection, and binarization. With use of normalization better results are achieved at feature extraction stage. Contrast enhancement is very important if there is a bad lighting.

The following methods are applied in order to prepare input image for further processing:
Noise Reduction—A blur filter is applied to eliminate the fine grain noise.
Contrast enhancement—This method computes gray level histogram and recalculates pixel values in order to use full range of available gray levels.
Polarity determination—Method is based on black and white pixels ratio in thresholded image. At this point it is not necessary to determine optimal threshold. Thresholded image is only used to calculate approximate values of number of black and white pixels. If it's needed image should be inverted in order to get bright characters on dark background
Character Segmentation—The algorithm segments binary image into regions that contain individual characters. Each of regions is represented by character rectangle. A character rectangle is a smallest rectangle enclosing the character.

Convolution operations, thresholding, connected component analysis, and vertical and horizontal projections are used to segment characters. However the algorithm that employs this stage assumes that some joined characters will be segmented as one character and some characters will be segmented into more than one piece. Later stages of processing attempt to split a region or join one or more to form a single character.

The idea is to detect regions of significant changes in the image that represent character, or character edges. This approach is used instead of standard thresholding method because it is insensitive to non-uniform background, and avoids use of unreliable thresholding methods.

The Character Segmentation 176 is Performed in the Following Steps:
Laplacian of Gausion (LOG)—Laplacian of Gaussian operator of 7×7 window size is applied in order to enhance regions of changes (characters), and avoid problem of slope background. The Laplacian is applied to an image that has first been smoothed with Gaussian filter in order to reduce its sensitivity to noise. Using Laplacian of Gaussian mask, the LoG can be calculated using standard convolution methods.
Thresholding—Image that results from LOG operator should be thresholded in order to generate binary image. The fixed threshold is used because LOG operator rejects bias (background information) and only changes in image are present. Proper threshold suppresses all small changes in image, such a noise or some defects. The white pixels in binary image represent character blobs. Thresholding with fixed threshold in conjunction with LOG produces better results, than some standard thresholding, or adaptive thresholding techniques.
Generation of horizontal and vertical profiles—This method determines horizontal and vertical profiles by summing white pixels in horizontal or vertical projection. Horizontal and vertical profiles are used to determine approximate values of some character parameters:
   characters region that contained individual characters (xmin, xmax, ymin, ymax)
   minimum height of characters (minHeight)
   maximum height of characters (max Height)
   minimum width of characters (minWidth)
   maximum width of characters (maxWidth)
   streak thickness—“pen size” (streakThickens)
   assumed character width (charWidth)
   assumed character height (charHeight)
Labeling—It labels white regions and add region dimensions to character rectangles array. A recurrent function is used, which checks 8-neighbors using white start-point. If neighbor pixel belongs to the region it is the start point for new function call. All white blobs in the entire image are labeled at this point. Each of the blobs is represented by one rectangle in the rectangle array. The rectangles consist of character rectangles, but also and rectangles that represent non-character blobs. The undesirable rectangles can be removed using methods based on statistical approach.
Irregular Rectangles Removal—The method for filtering irregular rectangles based on determined statistic parameters. It rejects:
   small objects that have width or height less than minWidth, and minHeight
   white stripe objects that have width>2*charWidth, and height<2*minHeight
   big objects that have width greater than maxWidth, and maxHeight, and position out of boundaries xmin, xmax, ymin, ymax
   overlapped rectangles, rectangle that intersects another one, and has smaller area
Vertical merging—In case that one of rectangles is above the other, method recalculate dimension of new rectangle as a union of those two rectangles.
Filtering of non-character areas—This method removes white pixels outside detected rectangles in order to prepare binary image for recalculating horizontal and vertical profiles, and statistical parameters.
Rectangles filtering—Keeps all rectangles inside the range (ymin, ymax), and rejects rectangles that are out of the characters region
Region splitting—Method splits rectangle using the vertical profile. If width of a rectangle is greater than assumed maximum width of character it is a candidate for connected characters. The rectangle is split if there is a black gap in vertical profile.
Region merging—Method checks two adjacent character rectangles whether they are parts of a broken character and broken parts are connected. If two adjacent rectangles have the difference between right side of right rectangle, and left side of left rectangle smaller than assumed maximum width of character, then those ones became the candidates for merging. The first step is to determine the region for analysis, which is the gap between adjacent rectangles. Then Thresholding is applied to this region, and threshold value is chosen as a minimum Threshold. If thresholded object exists, and links left and right side of region it means that there is no discontinuity and characters are connected. The result of this stage is an array of rectangles that represent character positions in the input image.

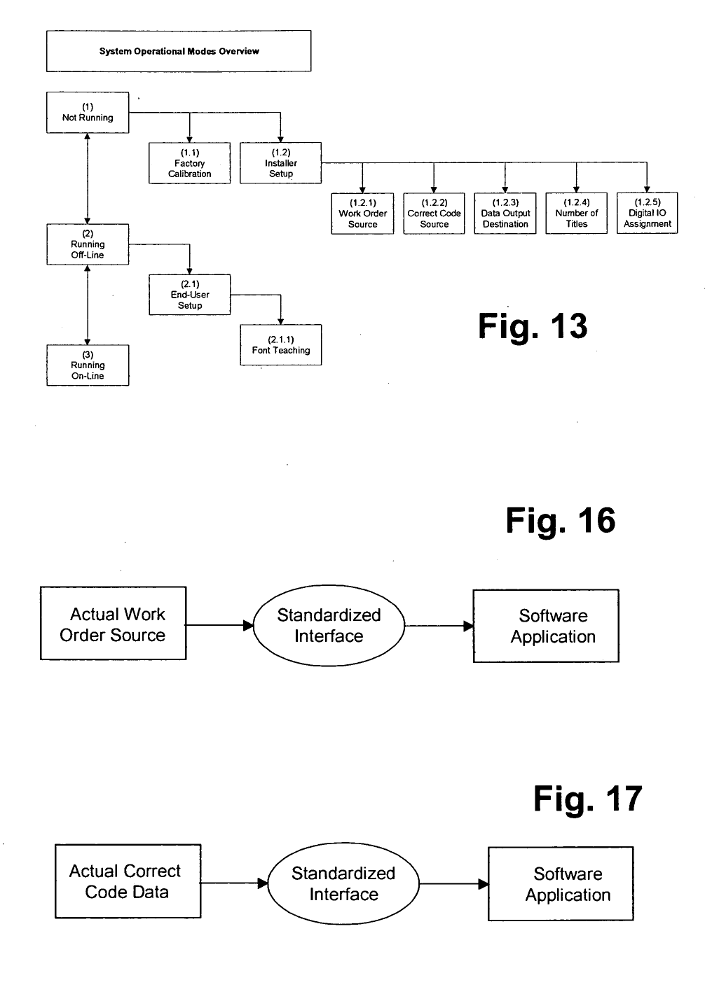

The ID Software System has three main operational modes as illustrated in FIG. 13. The modes for the software system are, Not Running, Running Off-Line, and Running On-Line. The majority of system functionality can be described through description of the Running On-Line mode.

1 Not Running—In this mode, the main application is not running, and various configuration programs are used to define the settings which the main application will eventually use.

1.1 Factory Calibration—This is process whereby a specially printed target disc is placed on the centering pin, to assist in aligning, focusing, and setting the aperture of the camera. Special software is used in order to locate specific targets on the disc. Once the targets have been located, their position is used to determine the offset between the centre axis of the camera and the centre position of the disc. The brightness observed is used to provide feedback for aperture adjustment. The contrast observed is used to provide feedback for focusing the camera lens.

1.2 Installer Setup—This is a process whereby the Installation Technician can configure the main software system based on customer's requirements. Specific options in the main software can be configured and/or enabled by the Installation Technician, instead of Xiris producing special versions of the main software for specific customers. Additionally, this provides the benefit of isolating certain system parameters which need only be sent once from inadvertent manipulation by unqualified end-users.

1.2.1 Work Order Source—During on-line operation, the ID system can collect a Work Order Number at the beginning of each batch of discs. This Work Order Number can be used to reference a database in order to determine more information about the batch or simply for recording in the production reports for the end-user's tracking purposes. In this process, the Installation Technician can select the desired source for a Work Order Number, for example “None”, or “Keyboard Entry”.

1.2.2 Correct Code Source—During on-line operation, the ID system can use data from an external source in order to determine the correct ID codes for the batch, for example “Keyboard Entry” or “Remote Database”. In this process, the Installation Technician can select the desired source for the correct codes.

1.2.3 Data Output Destination—During on-line operation, the ID system can send data about the discs to a remote device via different protocols and transport mechanisms. In this process, the Installation Technician can select the desired destination for output data.

1.2.4 Number of Titles—The ID system can be configured to process one or more disc-title streams (from one or more cameras). In this process, the Installation Technician can select the number of systems, and select the image acquisition hardware to be associated with each disc-title stream.

1.2.5 Digital I/O Assignments—The ID system can be configured to use different assignments of logical meanings to different physical input and output channels.

2.0 Running Off-Line—In this mode, the ID system may be configured by the end user, but will not inspect discs.

2.1 End-User Setup—Access to configuration items is restricted based on user-access level, which may be ascertained by a login sequence with user-name and password, or other methods.

Font Teaching (2.1.1)
Single-Character—A method for teaching the system one character at a time, by example from a digital image of a disc, by the user drawing a box around the example character and identifying the character using the keyboard.
Multiple-Character—A method for teaching the system multiple characters at a time, by example from a digital image of a disc. The user draws a box around the group of characters and identifies the sequence of characters using the keyboard. A method whereby the software can, within the user-specified box, automatically detect the bounding boxes for each of the specified characters.

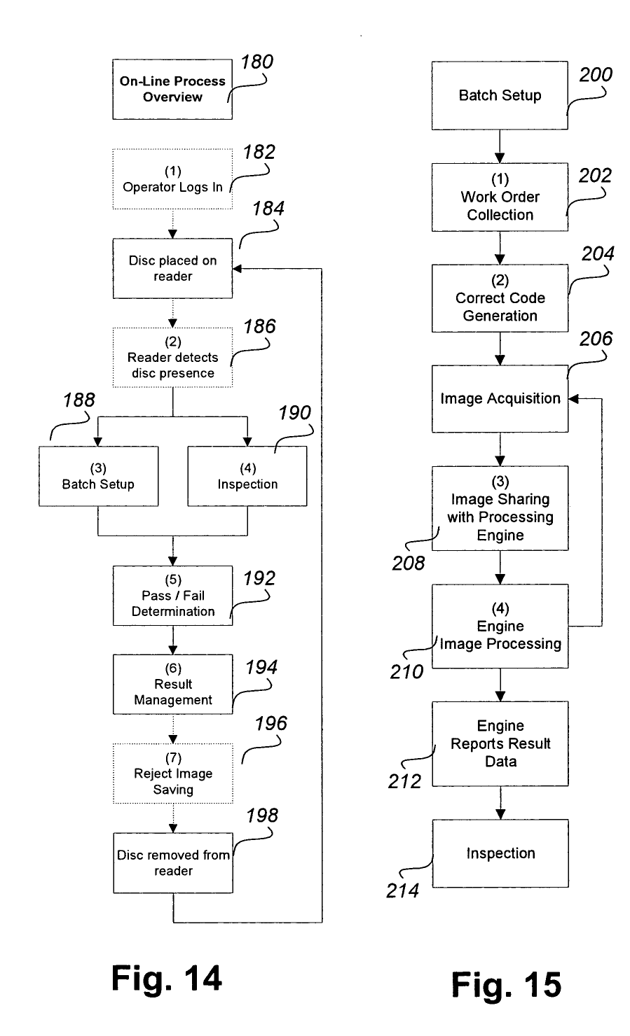

3.0 Running On-Line—In this mode, the ID system interfaces with external equipment. This mode is described below in further detail with regard to FIG. 14.

Referring to FIG. 14 there is illustrated in a flow chart an overview of the online process 180. The process begins with Operator Log-In 182.
An optional process whereby the user identifies himself to the system, and thereby obtains authority to execute certain functions.
The process to track and record all users who are associated with operating the system during a specific production run or batch.

A disc is place on the reader 184 by the pick and place apparatus. Then the system performs a Disc Presence Detection 186.
The presence of the disc can be detected through IR sensors.
The presence of the disc can-be verified through machine vision techniques.

One a disc has been detected 186; either a Batch Setup 188 or an Inspection 190 process can begins. Which process is used depends on direction provided by the operator, or provided by interfacing with a controlling machine or system.

The Batch Setup Process 188 Includes
the ID system determining the necessary parameters for the processing of the batch. These parameters include, but are not limited to, Work Order number, correct codes, and optimal image acquisition parameters.
During the process, the system can (depending on configuration) interface with remote data sources, interface with operators, and/or acquire images of sample discs to automatically or semi-automatically determine the required information.

The batch setup process is further described below with reference to FIG. 15.

The Inspection Process 190 Includes:
the system determining if the disc presented has the same, or substantially the same, identification codes as those which were determined to be correct during the previous Batch Setup process.

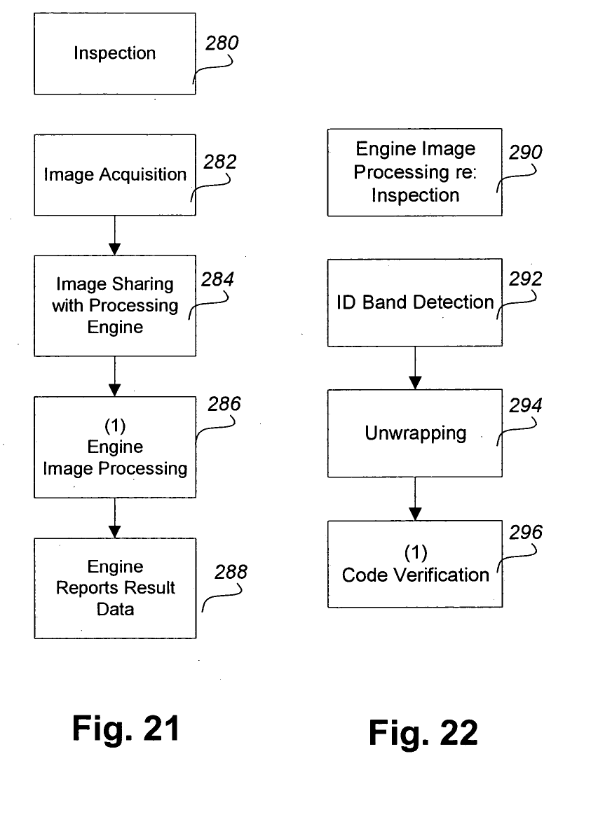

The Inspection process 190 is further described below with reference to FIG. 21.

The Pass/Fail Determination 192 Includes:
the system determining if a sufficient subset of the codes on the disc are acceptable in order to qualify that the disc as a whole is acceptable.
The end-user may configure the system such that, where multiple codes exist on the ident band, that all must be acceptable matches, or that only one need be an acceptable match.

The Result Management 194 Includes:
Once the Pass/Fail determination has been made, an output method can be used to inform the host equipment of the inspection result.
Another output method can be used to indicate the difference between an unreadable ident bad and a non-matching code.
A process whereby the logical relationship between the output function informing the host of the inspection result and the actual output method used, can be different for installations on different equipment, without changing the software.
When a disc is rejected, information concerning that disc can optionally be saved in memory for display in a “Reject History” list for the current batch.
When a disc is rejected, information concerning that disc can optionally be saved in a “Production Log File” on the PC's hard drive.

Reject Image Saving 196 Includes:
When a disc is rejected, a copy of the image of the disc can optionally be copied to another process running on a very low priority thread. This process saves the image to the PC's hard drive in such a manner as to not interfere with the timely processing of other discs.

Further detail of Batch Setup 200 is shown in FIG. 15. The process begins with Work Order Collection 202. The work order number can be omitted, or be collected via one of the following methods:
Keyboard
RS-232 Scanner
   A software process using a standardized interface allows for extensibility to yet-unknown methods of Work Order collection with minimal programming effort as shown in FIG. 16.

The next step is Correct Code Generation 204. The correct codes to be used for the batch are determined using one of the following methods:

1. Extracted from an image of a disc, using a set of rules known as Presets.

2. Entered by the Operator using the PC Keyboard

3. Scanned in by the Operator using an optical bar code scanner, from a Work Order sheet

4. Retrieved from a customer's database, using a customer-specific protocol, based on the Work Order number as a key

5. Retrieved from a text file on the PC or a network-connected PC. This text file is generated by the host equipment.

6. Retrieved from a database of recent jobs, for which the correct codes were determined based on method (1) and saved in the database keyed by the Work Order number.

A software process using a standardized interface allows for extensibility to yet-unknown methods of Correct Code Data collection with minimal programming effort as shown in FIG. 17.

After image acquisition 206, is Image Sharing with Processing Engine 208. This is a method whereby the image acquired in the main portion of the software application can be shared with a processing engine running in a different process. This avoids the time overhead of copying images over inter-process boundaries. Engine Image Processing 210, Engine Reports Result Data 212 and Inspection 214 complete the batch setup process 200.

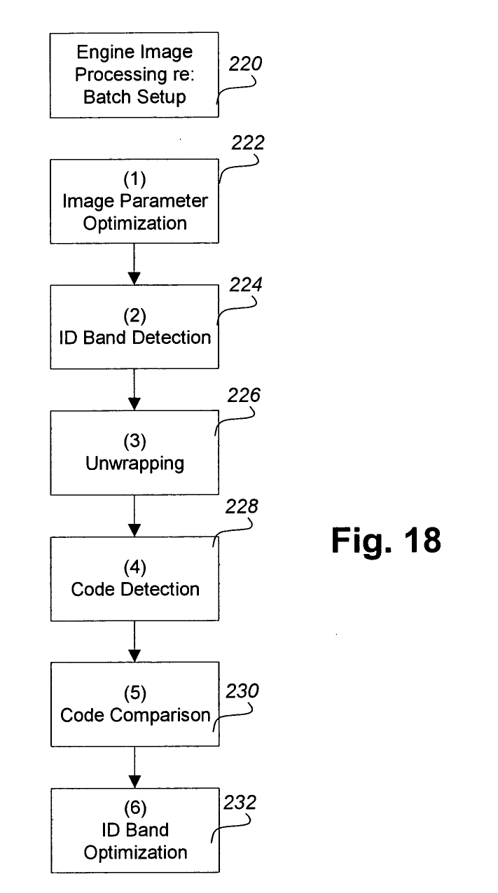

The Engine for Batch Setup is further described below with regard to FIG. 18. The Image Processing Engine 210 for Batch Setup provides image processing and machine vision operations that are performed in an out-of-process server, known as an Engine. One such Engine exists for each disc-title. This allows asynchronous processing of each disc-title stream. During the Batch Setup process 210, the Engine may request additional images from the main application. The process begins with Image Parameter Optimization 222, a process for automatically determining, based on the first disc of the batch, the optimal values for the image acquisition. These parameters include, but are not limited to, the following:
Digitization Black Level
Digitization White Level
Brightness
Contrast
Exposure Time
Light Color Content
Autofocus

The next step is ID Band Detection 224, a process for detecting the centre position of the ID Band in the digitized image. This is followed by Unwrapping 226, a process for generating a rectangular representation of the annular ID band, as graphically illustrated in FIG. 19. Correct unwrapping requires that the precise centre position of the band be detected via step 224. The next step is Code Detection 228, a process for determining what codes are actually present on a disc. This process is described in more detail below with regard to FIG. 20.

Code Comparison 230 is a process for determining if one code is substantially equivalent to another. Users may define a delimiter character, which indicates the last character to be compared when determining substantial equivalency. For the Batch Setup process to succeed, the code(s) actually on the disc on the camera must be substantially equivalent to that determined during the Correct Code Generation phase.

ID Band Optimization 232 is a process whereby the radial position of the located ident-codes, within the ident-code band, is used to reduce the radial size of the unwrapping operation for the rest of the batch.

Referring to FIG. 20 there is illustrated Code Detection Details 240. Code detection 242 includes automatically or semi-automatically detecting one of three types of discerning patterns on the ident band, with or without a priori knowledge of the content of these patterns. The pattern types are 1) Alphanumeric Codes 244, 2) Bar Codes 246, 3) General Models 248.

Alpha Code Reading 244 Involves the Following:
Character Segmentation 250, process for detecting rectangular regions in the image which contain only one character
Character Matching 252 a process of matching the pattern in each rectangular region against an internal database of known characters, in order to determine which character is present.
Sub-Code Selection 254, once the system has detected all possible strings of characters, in the absence of a priori correct code information, the system implements a process whereby the operator can easily select which characters should be inspected.

Search Model Generation 256, to enhance speed of future inspection operations, a search model of the characters is created.

Bar Code Scanning 246 Involves:
Expected Edge Count Method 260, a process for detecting bar codes even when foreign matter on the disc creates additional artifacts which would normally be interpreted as low-strength bars. This is based on locating the START and STOP characters within the bar code, and using knowledge of the bar code geometry to deduce the expected number of bars, and reduce the probability of interpreting foreign matter as a bar by considering only the strongest bars.

Configurable For Direction 262 is a process whereby the user can allow for detection of codes in either a CW or CCW direction, or both.

Search Model Generation 264 is use to enhance speed of future inspection operations, a search model of the START cell is created.

Model Definition 248
Should bar codes not be present, and alphanumeric inspection not be possible, the user (depending on his privilege level) may define a region of the ID band to be used as a master image for a pattern-matching inspection.

The Inspection process 280 is shown in further detail in FIG. 21. After image acquisition 282, is Image Sharing with Processing Engine 284, followed by Engine Image Processing 286, and Engine Reports Result Data 288 completes the Inspection 280.

The Engine Image Processing re Inspection process 290 is shown in further detail in FIG. 22. After ID Band Detection 292, is Unwrapping 294, followed by Code Verification 296.

Code Verification 296 is process of verifying that the code on the disc under inspection is with a high likelihood the same as expected. This is different from reading the code, in that it gives a “go/no-go” response.

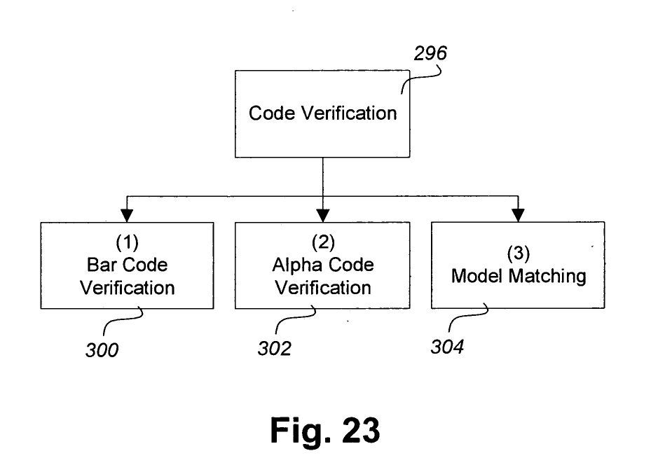

Referring to FIG. 23, Code Verification Details 296 are illustrated.

Bar Code Verification 300 includes multiple processes used for Bar Code Verification.
The first step is a Bar Code Detection, as described above, but restricted to the type of bar code that was detected on the first disc, i.e. Code 39.
Should that find a bar code, it will be compared to the correct bar code and, if it substantially matches (as defined above), then the bar code is verified. process whereby the system searches for the pattern of the bar code, and if it succeeds, it then analyzes the bar code cell-by-cell. If the pattern of bars and spaces is closer to the expected pattern than to any other pattern, then the cell is deemed verified. If each cell is verified, then the bar code as a whole is deemed verified.

Alpha Code Verification 302

Model Matching 304 is process whereby if the pattern as “taught” during the Batch Setup phase can be located in the ID band, then the disc will be judged to be “good”.

Numerous modifications, variations and adaptations may be made to the particular embodiments of the invention described above without departing from the scope of the invention, which is defined in the claims.

What is claimed is:

1. An apparatus for identifying optical storage media comprising:
a computer system having a CPU, a keyboard, a display unit and a media identification module; and
a camera head having a multi-spectral lighting system.

2. An apparatus as claimed in claim 1 wherein the camera head includes a camera chamber having an optical window.

3. An apparatus as claimed in claim 2 wherein the camera head includes an air flow through system for keeping the optical window clear of foreign particles that would affect operation.

4. An apparatus as claimed in claim 1 wherein the camera head includes a media detection system.

5. An apparatus as claimed in claim 4 wherein the media detection system includes space infrared sources and detectors for determining present and/or position on optical media place on the camera head.

6. An apparatus as claimed in claim 1 wherein the camera head includes a media-centering pin assembly.

7. An apparatus as claimed in claim 6 wherein the media centering pin assembly includes a resiliently biased pin.

8. An apparatus as claimed in claim 1 wherein the camera head includes a chassis.

9. An apparatus as claimed in claim 8 wherein the chassis includes an extruded body.

10. An apparatus as claimed in claim 9 wherein the extruded body includes a camera chamber and a plurality of airflow chambers.

11. An apparatus as claimed in claim 1 wherein the multi-spectral lighting system includes a plurality of light-emitting diodes.

12. An apparatus as claimed in claim 1 wherein the plurality of light-emitting diodes includes different colours.

13. An apparatus as claimed in claim 12 wherein the camera head includes a controller for controlling each of the plurality of light-emitting diodes.

14. An apparatus as claimed in claim 13 wherein the controller includes intensity control.

15. An apparatus as claimed in claim 13 wherein the controller includes phase control.

16. A method of identifying optical storage media comprising the steps of:
capturing an image of an identification ring disposed upon an optical media disc;
unwrapping the ring to form a flat band;
searching of the flat band to locate a full string of graphic symbols or characters;
segmenting the string into individual symbols or characters;
identifying problem symbols or characters associated with the individual symbols or characters; and
checking each individual symbol or character to determine an acceptable symbol or character and comparing the individual symbol or character to both the acceptable symbol or character and the associated problem symbol or character to determine which is a closer match.

17. An apparatus for identifying optical storage media comprising:
means for capturing an image of an identification ring disposed upon an optical media disc;
means for unwrapping the ring to form a flat band; means for searching of the flat band to locate a full string of symbols or characters;
means for segmenting the string into individual symbols or characters;
means for identifying problem symbols or characters associated with the individual symbols or characters; and
means for checking each individual symbol or character to determine an acceptable symbol or character and comparing the individual symbol or character to both the acceptable symbol or character and the associated problem symbol or character to determine which is a closer match.
